(19) United States
(12) Patent Application Publication
(10) Pub. No.: US 2010/0035738 A1
(43) Pub. Date: Feb. 11, 2010

(54) MACHINE TOOL SHIELD

(76) Inventor: Donald W. Smith, JR., Guilford, CT (US)

Correspondence Address: LAW OFFICES OF RAYMOND A. NUZZO, LLC, 579 THOMPSON AVENUE, EAST HAVEN, CT, 06512, US

(21) Appl. No.: 12/524,808

(22) PCT Filed: Feb. 4, 2008
(86) PCT No.: PCT/US08/52963

§ 371 Date: Jul. 31, 2009

Related U.S. Application Data
(60) Provisional application No. 60/899,825, filed on Feb. 6, 2007.

(51) Int. Cl. B23Q 11/08; A44B 99/00

(52) U.S. Cl. 483/3; 409/134; 24/457; 24/458

(57) ABSTRACT

A machine tool shield having a base frame comprising a pair of lengthwise base frame members and a pair of widthwise base frame members. The lengthwise and widthwise base frame members are arranged in the shape of a square or rectangle having four corners. The base frame is positioned upon a waterproof membrane. The machine tool shield further comprises a plurality of corner clip members. Each corner clip member is mounted to one of the lengthwise base frame members and one of the widthwise base frame members wherein the one of the lengthwise base frame members and the one of the widthwise base frame members abut each other to form one of the corners. Each corner clip member has a vertically oriented bore therein. The machine tool shield includes a shroud support frame comprising a plurality of vertically oriented members. Each of the vertically oriented members has an end portion that is disposed in a corresponding one of the vertically oriented bores. A shroud is removably secured to the shroud support frame to form a shield.

### CROSS-REFERENCE TO RELATED APPLICATIONS

This application claims the benefit of U.S. Provisional Application No. 60/899,825, filed Feb. 6, 2007.

### BACKGROUND OF THE INVENTION

1) Field of the Invention

The present invention generally relates to a shield for a machine tool.

2) Description of Related Art

Machine tools, such as various types of tile cutting machines, lathes, mills, drills, saws, etc., are widely used by craftsmen, tradesmen, and laypeople for a wide variety of jobs or projects. For example, wet saws are used to cut tiles, stones, masonry, etc. Such saws use a water spray directed on or near the cutting blade to facilitate cutting of the tile and to prevent circulation of dust and particles. However, such saws create runoff or wastewater that can accumulate under or near the saw creating a safety hazard. Other types of machine tools can also create dust and or debris that, if not confined, will result in significant clean-up time and possibly a safety hazard.

Various types of attachments, enclosures or shields for machine tools are currently available. Many of these attachments, shields or enclosures are safety shields for preventing the operator from being accidentally cut or injured by the tool during operation. However, such safety shields are not configured to confine dust, debris, dirt, particle or water or fluid runoff.

Other available machine tool enclosures are similarly rigid and bulky. For example, U.S. Pat. No. 5,457,915, entitled “Tile Saw Machine” and U.S. Pat. No. 5,577,955, entitled “Portable Tile Saw Shield” disclose a machine tool shield that includes a number of rigid, transparent plastic panels made from materials such as Plexiglas ®. However, such a shield cannot be easily or conveniently stored, and thus cannot be easily disassembled, cleaned, and packed away for easy and convenient transportation and/or storage. U.S. Patent Application Publication No. 2006/0243312, entitled “Collapsible Enclosure For A Machine Tool”, describes an enclosure for a machine tool that uses a collapsible frame that in one embodiment, comprises a relatively high number of parts and components, such as tube-like members, a plurality of pivoting joints and a plurality of hinge members.

What is needed is a new machine tool shield that is easy to assemble, disassemble and transport, and which uses a minimum of parts or components.

### DISCLOSURE OF THE INVENTION

It is an object of the present invention to provide a machine tool shield that uses a minimum number of parts.

It is another object of the present invention to provide a machine tool shield that uses parts that are not prone to fatigue and wear.

It is another object of the present invention to provide a machine tool shield that can be manufactured at reasonable costs.

It is a further object of the present invention to provide a machine tool shield that can be configured in kit form.

Thus, the present invention is directed to, in one aspect, a machine tool shield, comprising a base frame comprising a pair of lengthwise base frame members and a pair of widthwise base frame members. The lengthwise and widthwise base frame members are arranged in the shape of a square or rectangle having four corners. The machine tool shield further comprises a plurality of corner clip members. Each corner clip member is mounted to one of the lengthwise base frame members and one of the widthwise base frame members wherein the one of the lengthwise base frame members and the one of the widthwise base frame members abut each other to form one of the corners. Each corner clip member has a vertically oriented bore therein. The machine tool shield further comprises a shroud support frame comprising a plurality of vertically oriented members. Each of the vertically oriented members has an end portion that is disposed in a corresponding one of the vertically oriented bores. A shroud is wrapped about and removably secured to the shroud support frame to form a shield.

Other embodiments of the invention are described herein.

Other features of the present invention will be apparent from the accompanying drawings and from the detailed description that follows.

### BRIEF DESCRIPTION OF THE DRAWINGS

The foregoing features of the present invention will become more readily apparent and may be understood by referring to the following detailed description of an illustrative embodiment of the present invention, taken in conjunction with the accompanying drawings, in which:

FIG. 1A is a perspective view of the machine tool shield in accordance with one embodiment of the present invention;

FIG. 1B is a perspective view of the machine tool shield of FIG. 1A, the view not showing the shroud shown in FIG. 1A in order to facilitate viewing of the base frame and shroud support frame;

FIG. 2 is a plan view of the base frame of the machine tool shield of FIG. 1A, the view not showing the shroud support frame so as to facilitate viewing of the base frame;

FIG. 3 is a plan view of a center clip member shown in FIG. 2;

FIG. 4 is a view taken along line 4-4 of FIG. 2;

FIG. 5 is a cross-sectional view taken along line 5-5 of FIG. 2;

FIG. 6 is a side view of a center clip member shown in FIG. 2;

FIG. 7 is a top plan view of a corner clip member shown in FIG. 2;

FIG. 8 is a bottom view of the corner clip member shown in FIG. 7;

FIG. 9 is a cross-sectional view taken along line 9-9 of FIG. 7;

FIG. 10 is a cross-sectional view taken along line 10-10 of FIG. 7;

FIG. 11 is a view taken along line 11-11 of FIG. 7; and

FIG. 12 is a view taken along line 12-12 of FIG. 7.

### BEST MODE FOR CARRYING OUT THE INVENTION

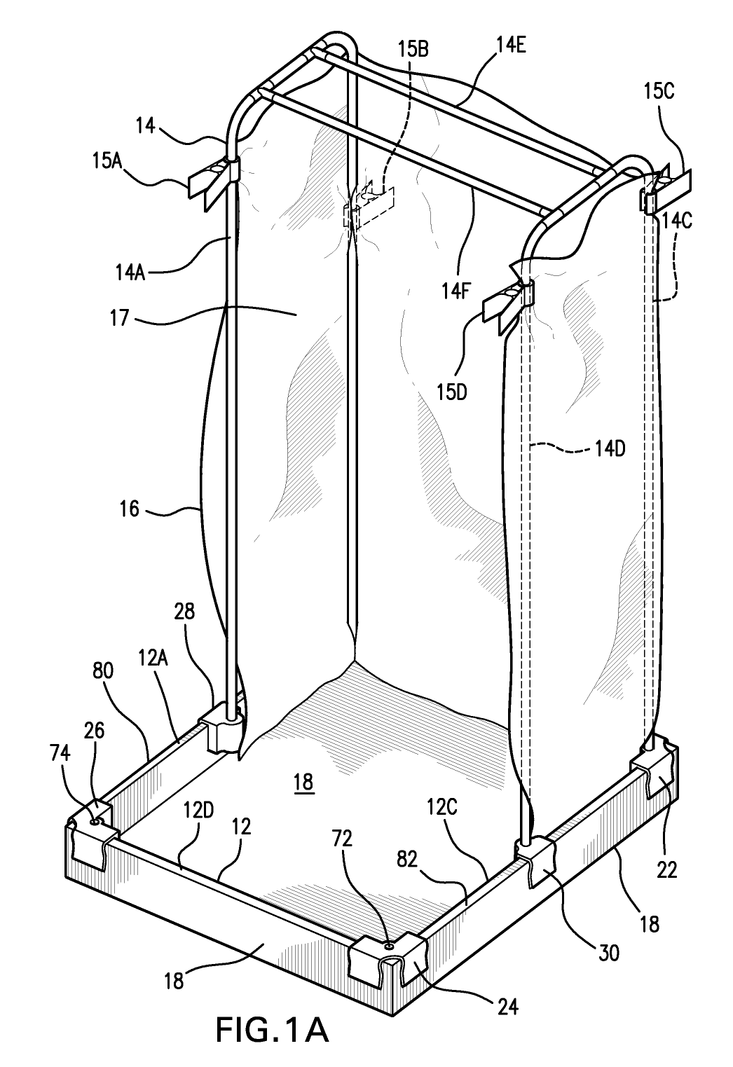

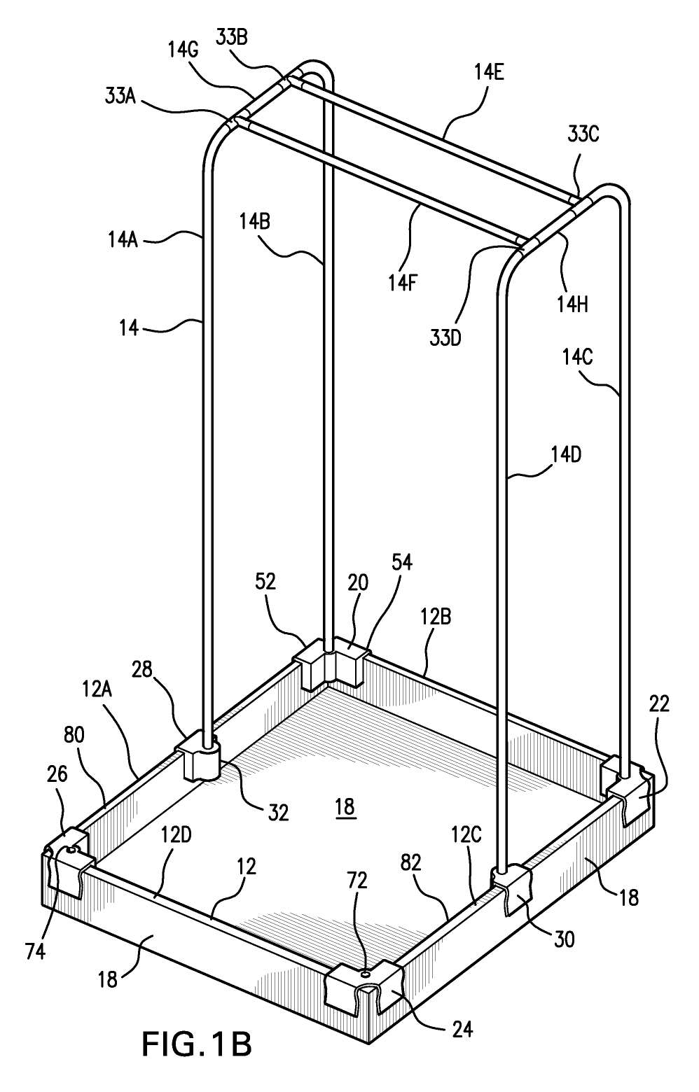

Referring to FIGS. 1A and 1B, there is shown machine tool shield 10 in accordance with one embodiment of the present invention. Machine tool shield 10 has a base frame 12 that is comprised of frame members 12A, 12B, 12C and 12D. Machine tool shield 10 further comprises shroud support frame 14 and shroud or cover 16. Shroud 16 is wrapped about shroud support frame 14 and is secured to shroud support frame 16 with clamp devices 15A-D or similar devices. Shroud 16, when secured to shroud support frame 14, forms a shield 17. In one embodiment, shroud or cover 16 may be constructed from a lightweight and flexible yet waterproof material such as vinyl or waterproof-treated nylon or canvas. In another embodiment, shroud 16 is fabricated from material that is not waterproof. Thus, shroud or cover 16 may be folded and/or rolled for storage when machine tool shield 10 is disassembled. In a preferred embodiment, shroud or cover 16 may be constructed of a clear, vinyl or similar material to allow light to pass through and allow viewing of the machine tool and work pieces from outside the shield 17. As will be discussed in the ensuing description, a machine tool is placed within shield 17. Base frame 12 is positioned upon membrane 18. In one embodiment, membrane 18 is waterproof. Membrane 18 can be configured as a plastic sheet, a waterproof canvas, or other suitable material that may or may not be waterproof. Frame members 12A, 12B, 12C and 12D are held together by corner clip members 20, 22, 24 and 26. Each corner clip member 20, 22, 24 and 26 is identical in construction. Machine tool shield 10 further comprises center clip members 28 and 30. Center clip members 28 and 30 are identical in construction and are further discussed in the ensuing description.

Referring to FIG. 1B, shroud support frame 14 comprises vertical members 14A, 14B, 14C, and 14D, and horizontal members 14E, 14F, 14G and 14H. Shroud support frame 14 further comprises joint members 33A, 33B, 33C and 33D. Each joint member 33A-D may be configured as a commercially available “T” joint commonly used with PVC tubing or electrical conduit tubing. Each vertical member 14A-D has a curved upper portion that is joined to a corresponding one of the “T” joint members 33A-D. Members 14A, 14G and 14F are removably joined to joint member 33A. Members 14B, 14G and 14E are removably joined to joint member 33B. Members 14C, 14H and 14E are removably joined to joint member 33C. Members 14D, 14F and 14H are removably joined to joint member 33D. Each member 14A-14H and joint member 33A-D may be constructed from a variety of materials, but preferably, is fabricated from lightweight corrosion resistant material such as various plastics, including but not limited to, polyvinylchloride (PVC), thermoplastics, etc. Alternatively, each member 14A-14H may be constructed of other materials such as aluminum or stainless steel tubing. In one embodiment, each base frame member 12A-D is configured as pressured-treated wood.

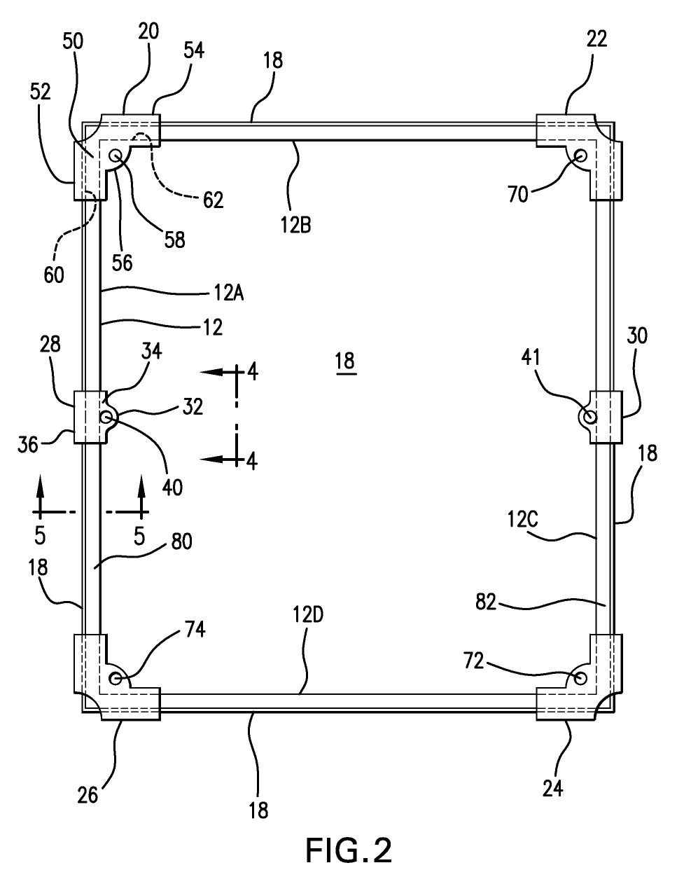

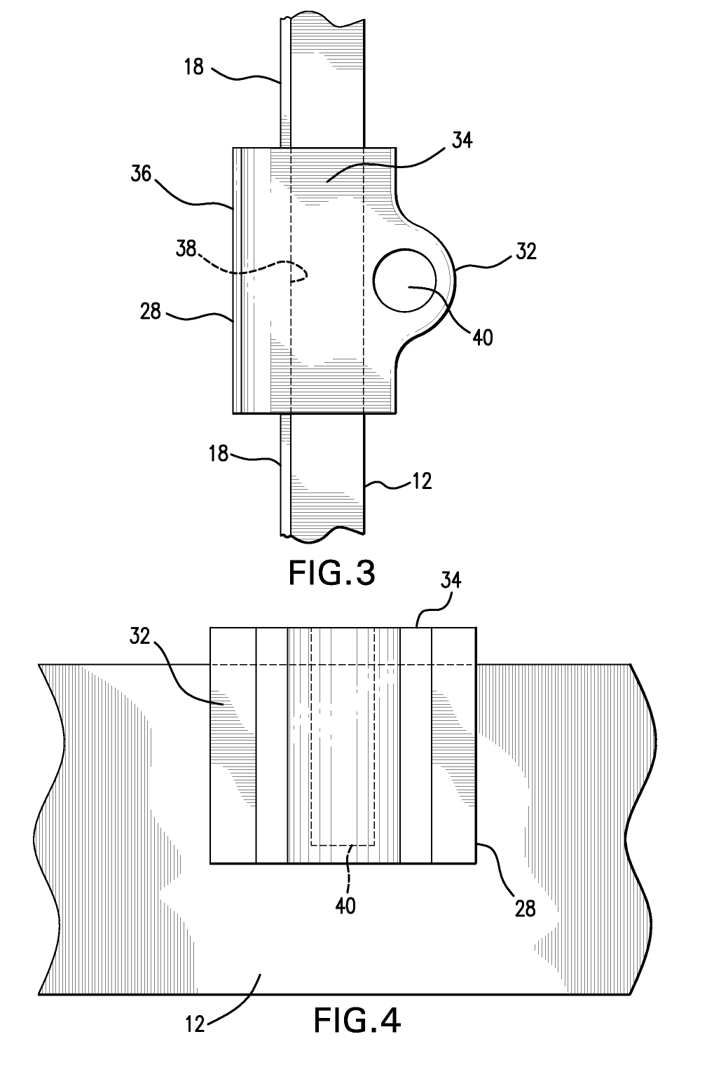

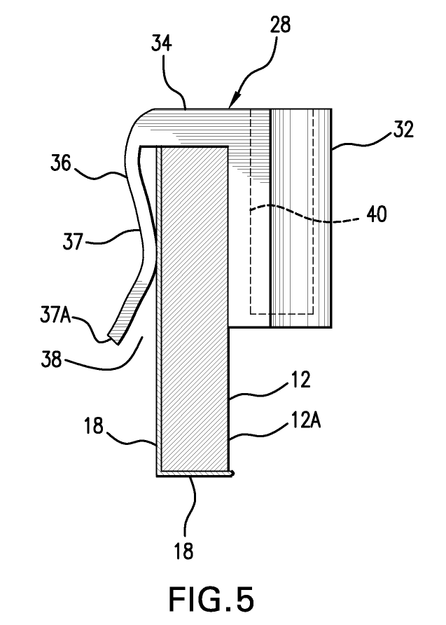

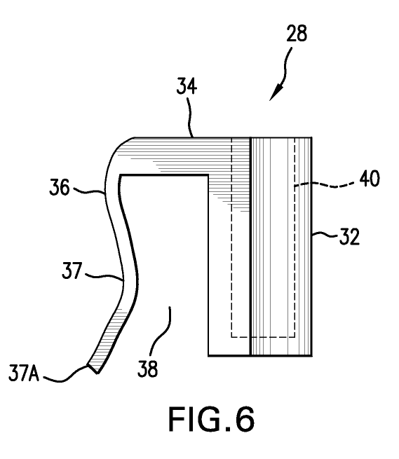

Referring to FIGS. 1A, 1B and 2-6, center clip member 28 comprises body portion 32, top portion 34 and curved arm member 36. Curved arm member 36 has a central, curved portion 37 and a distal end 37A. Curved arm member 36 has a slight degree of resiliency. Space or channel 38 is formed between body portion 32 and curved arm member 36. Space or channel 38 is sized to receive a portion of base frame member 12A as shown in FIGS. 1A, 1B, and 5. The degree of resiliency of curved arm member 36 provides a frictional relationship between center clip member 28 and base frame member 12A. The peripheral or outer portions or flaps of membrane 18 can be inserted between curved arm member 36 and base frame member 12A as shown in FIG. 5. Center clip member 28 has a bore 40 located in body portion 32. Bore 40 is sized to receive a corresponding frame member of shroud support frame 14. Specifically, as shown in FIGS. 1A and 1B, the end portion of support frame member 14A is disposed within bore 40. Similarly, center clip member 30 has bore 41 for receiving the end portion of shroud support frame member 14D (see FIGS. 1B and 2). Since center clip members 28 and 30 are identical in structure and function, center clip member 30 is not described in detail. Center clip members 28 and 30 may be made from any suitable materials. In a preferred embodiment, center clip members 28 and 30 are fabricated from plastic. However, other suitable materials, such as PVC, rubber or composites, may be used as well. The position of center clip members 28 and 30 on base frame members 12A and 12C, respectively, may be adjusted in accordance with the size of shroud support frame 14. For example, in order to move center clip member 28 to a different position on base frame member 12A, the user grasps the distal end 37A of curved arm member 37 and pulls distal end 37A outward while simultaneously sliding center clip member 28 to the desired location upon frame member 12A. Referring to FIG. 2, base frame member 12D is at the front of machine tool shield 10 and base frame member 12B is at the rear of machine tool shield 10.

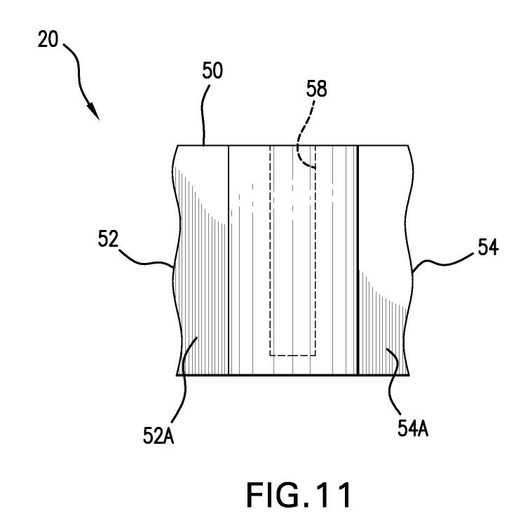

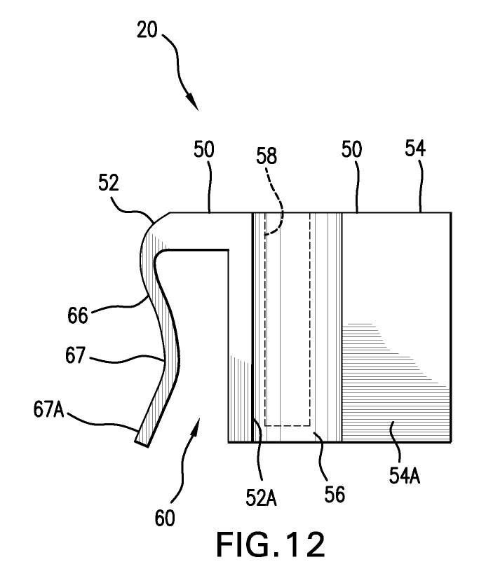

Referring to FIGS. 1A, 1B and 7-12, corner clip member 20 comprises top portion 50 and section 52. Section 52 has a wall portion 52A and a longitudinally extending axis 53. Corner clip member 20 further comprises section 54. Section 54 has a wall portion 54A and a longitudinally extending axis 54 that is substantially perpendicular to longitudinally extending axis 53. Corner clip member 20 further comprises central portion 56. Central portion 56 has bore 58 that is sized for receiving shroud support member 14B (see FIG. 1B). Section 52 has a space or channel 60. Space or channel 60 is sized to receive a portion of base frame member 12A. Similarly, section 54 has a space or channel 62 that generally intersects space or channel 60. Space or channel 62 is sized to receive a portion of base frame member 12B. Space or channels 60 and 62 are discussed in detail in the ensuing description.

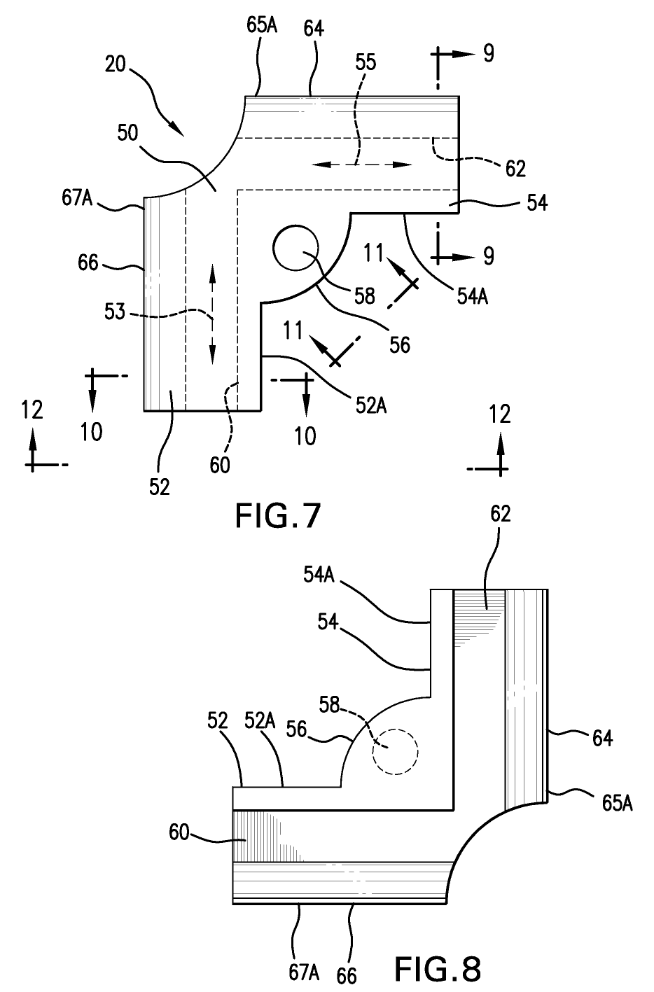

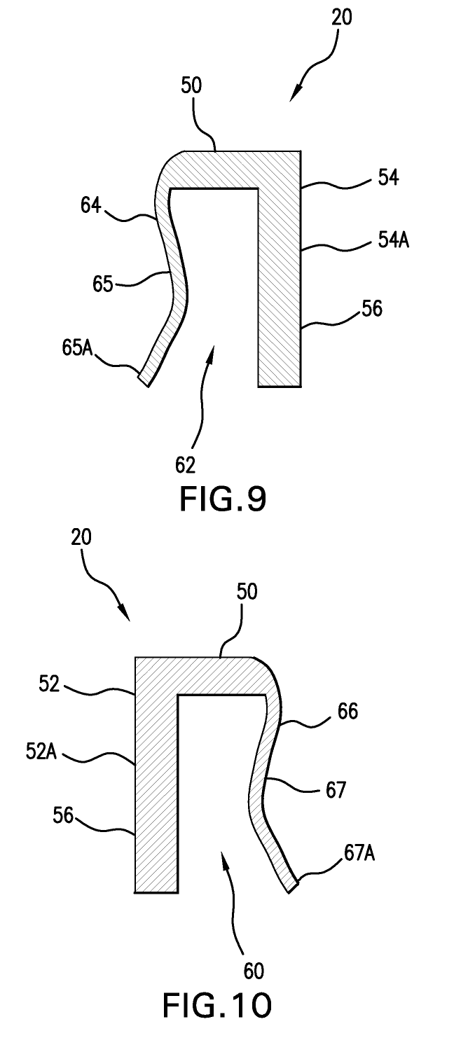

Central portion 56 is attached to sections 52 and 54 as shown in FIG. 7. Top portion 50 extends over sections 52 and 54. Referring to FIG. 9, wall portion 54A extends downward from top portion 50. Section 54 also includes curved arm member 64 that extends downward from top portion 50 such that space or channel 62 is between curved arm member 64 and wall portion 54A. Curved arm member 64 has a central curved portion 65 and distal end 65A. Referring to FIG. 10, wall portion 52A of section 52 extends downward from top portion 50. Section 52 also has curved arm member 66 that extends downward from top portion 50 such that space or channel 60 is between curved arm member 66 and wall portion 52A. Curved arm member 66 has central curved portion 67 and distal end 67A. As shown in FIG. 2, corner clip member 20 is mounted to both base frame members 12A and 12B and holds these base frame members 12A and 12B in an orthogonal relationship (i.e. at a right angle). In a preferred embodiment, curved arm members 66 and 64 have a degree of resiliency that provides a degree of friction between base frame member 12A and central curved portion 67, and between base frame member 12B and central curved portion 65. Thus, corner clip member 20 holds base frame members 12A and 12B together without the use of fastening devices such as nails or screws. Since clip corner members 20, 22, 24 and 26 are identical in construction, only corner clip member 20 has been described in detail in the foregoing description. Corner clip member 22 has bore 70 for receiving shroud support frame member 14C. Corner clip member 24 also has a bore 72 for receiving a vertical shroud support frame member. Similarly, corner clip member 26 has bore 74 for receiving a vertical shroud support frame member. Thus, corner clip members 24 and 26 allow for the use of a relatively larger shroud support frame and corresponding relatively larger shroud. The peripheral portions of membrane 18 can be inserted between curved arm member 66 and base frame member 12A, and between curved arm member 64 and base frame member 12B. This feature is discussed in detail in the ensuing description.

Corner clip members 20, 22, 24 and 26 may be made from any suitable materials. In a preferred embodiment, corner clip members 20, 22, 24, and 26 are fabricated from plastic. However, other suitable materials, such as rubber, composites, PVC, etc., may be used to fabricate corner clip members 20, 22, 24, and 26.

Referring to FIGS. 1A, 1B and 2, a table or other support can be placed within shield and positioned on membrane 18. The machine tool can be positioned on the aforesaid table or support. A platform, mat or similar device (not shown) can be placed between base frame members 12A and 12C and on membrane 18. The user may stand on the platform while using the machine tool. Alternatively, a plank, board, platform or similar device can be placed upon top edges 80 and 82 of base frame members 12A and 12C, respectively. The user can stand on the aforesaid platform, board, or plank while using the machine tool.

If water or other fluids are not used during the operation of the machine tool, then membrane 18 does not have to be waterproof. In such an embodiment, membrane 18 can be configured as a plastic tarp or canvas and a vacuum hose or evacuation fan may be placed at the rear of shield 17 to withdraw dust, debris and flying particles.

In order to assemble machine tool 10, a user first lays down membrane 18. Next, base frame members 12A-D are then positioned on top of membrane 18. Specifically, all frame members 12A-D are positioned on their edges and arranged so that base frame members 12B and 12D are parallel to each other and at right angles to base frame members 12A and 12C (see FIG. 2). Next, the user positions the peripheral portions of the membrane 18 against the outer sides of base frame members 12A and 12D, and then mounts center clip members 28 and 30 to base frame members 12A and 12D, respectively, so that the peripheral portions of the membrane 18 are firmly positioned between the base frame members and the curved arm member of each center clip member 28 and 30. For example, as shown in FIG. 5, a portion of base frame member 12A is positioned within channel or space 38 and the peripheral portion of membrane 18 is positioned between curved arm member 36 and base frame member 12A. With respect to the corner members 20, 22, 24 and 26, the user folds up the corners of membrane 18 to create flaps that are folded back. Next, the user slips the respective corner clip member on the base frame members and over the fold so that the curved arm member of the corner clip member slides over the fold. For example, corner clip member 20 is mounted to the base frame members 12A and 12B such that a portion of base frame member 12A is disposed within space or channel 60 of section 52, a portion of base frame member 12B is disposed within space or channel 62 of section 54, and the fold created by the user is firmly positioned between curved arm member 66 and base frame member 12A and between curved arm member 64 and base frame member 12B. This step is done for all corner clip members and results in protection of the corners and provides a degree of rigidity to the entire assembly. Next, the user then inserts the appropriate end of vertical member 14A into bore 40 of center clip member 30, and the appropriate end of vertical member 14D into bore 41 of center clip member 30. Next, the user inserts the appropriate end of vertical member 14C into bore 70 of corner clip member 22, and the appropriate end of vertical frame member 14B into bore 58 of corner clip member 20. The user then joins joint members 33A, 33B, 33C and 33D to vertical members 14A, 14B, 14C and 14D, respectively. Next, the user joins horizontal member 14G to joint members 33A and 33B, and horizontal member 14H to joint members 33C and 33D. The user then joins horizontal member 14F to joint members 33A and 33D, and horizontal member 14E to joint members 33B and 33C. Next, the user then wraps shroud 16 around or about vertical members 14A-D as shown in FIG. 1A. The user can then place a table or support on membrane 18 and within shield 17. The user can then position the machine tool on the table or support. Machine tool shield 10 is then ready for use. In order to disassemble machine tool shield 10, the user simply implements the steps above in reverse order.

Alternatively, when assembling machine tool shield 10, the corner clip members 20, 22, 24 and 26 may be mounted to base frame members 12A-D prior to mounting center clip members 28 and 30.

A significant advantage of machine tool shield 10 of the present invention is that the overall size of shield 17 can be varied in several ways. First, the user can assemble machine tool shield 10 so that vertical member 14A is secured in bore 74 of corner clip member 26 and vertical member 14D is secured in bore 72 of corner clip member 24. Horizontal members 14G and 14H are replaced by relatively longer horizontal members. An appropriately sized shroud is then secured to the enlarged shroud support frame.

Another way the machine tool shield of the present invention can be enlarged is to replace base frame members 12A and 12C with relatively longer members and also replace horizontal frame members 14G and 14H with corresponding relatively longer horizontal members. An appropriately sized shroud is then secured to the enlarged shroud support frame. In this configuration, membrane 18 is replaced with a relatively larger sized membrane.

Another advantage of the machine tool shield 10 of the present invention is that since membrane 18 is a flat piece of material, the corner folds become undone when membrane 18 is removed from the assembly. Thus, the membrane 18 has no permanent corners and can be easily cleaned and then rolled and/or folded up.

A further advantage of the present invention is that cut tiles can be placed within the shield and leaned against the base frame members 12A, 12B, 12C and 12D so that any water runs off the tiles and onto the membrane 18.

Machine tool shield 10 can be easily assembled and disassembled. It can be easily stored and transported. It uses a relatively fewer components than prior art machine tool enclosures. In one embodiment, machine tool shield 10 is configured as a kit that can be assembled by the user. Such a kit would include some or all of the components mentioned above.

In an alternate embodiment, each vertical member 14A-D is configured to have a hollow, tubular configuration, and wooden dowels are first inserted into bores 40, 41, 58, 70, 72 and 74. The vertical members are then mounted to the wooden dowels so that the dowels are disposed within the tubular structure of each vertical member 14A-D. Such a configuration provides the shroud support frame with a degree of flexibility.

Although the base frame 12 has been described as having a square or rectangular shape, it is to be understood that the base frame can have other shapes, e.g. triangular, octagonal, circular, etc. In some of these embodiments, the shape of clip members 20, 22, 24, 26, 28 and 30 would have to be modified to fit frames having different geometries.

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the invention. Accordingly, the foregoing detailed description should be considered as exemplary in nature and not as limiting the scope and spirit of the invention as set forth in the attached claims.

1. A machine tool shield, comprising:
a base frame comprising a pair of lengthwise base frame members and a pair of widthwise base frame members, said lengthwise and widthwise base frame members being arranged in the shape of a square or rectangle having four corners;
a plurality of corner clip members, each corner clip member being mounted to one of said lengthwise base frame members and one of said widthwise base frame members wherein said one of said lengthwise base frame members and said one of said widthwise base frame members abut each other to form one of said corners, each of said corner clip members having a vertically oriented bore therein;
a shroud support frame comprising a plurality of vertically oriented members, each of said vertically oriented members having an end portion that is disposed in a corresponding one of said vertically oriented bores; and
a shroud secured to the shroud support frame to form a shield.

2. The machine tool shield according to claim 1 each of said corner clip members have a first section having a first longitudinal axis, a second section having a second longitudinal axis that is substantially perpendicular to said first longitudinal axis, and a generally central portion that is joined to said first and second sections, said central portion having said vertically oriented bore therein for receiving an end portion of a corresponding one of said vertically oriented members.

3. The machine tool shield according to claim 2 wherein said first section and said second section have a top portion, a wall portion extending down from said top portion, and a curved arm member extending down from said top section, said wall portion and said curved arm member being separated by a channel or space that is sized or for receiving a portion of a lengthwise or widthwise base frame member of said base frame.

4. The machine tool shield according to claim 3 wherein said curved arm member has a degree of resiliency so as to allow said portion of said lengthwise or widthwise base frame member to be frictionally inserted into said channel or space.

5. The machine tool shield according to claim 1 further comprising a pair of center clip members, each center clip member being mounted to a corresponding base frame member that extends between the front and rear of said base frame, each center clip member being located between a pair of corner members.

6. The machine tool shield according to claim 5 wherein each center clip member has a top portion, a body portion extending down from said top portion, and a curved arm member extending down from said top portion, said body portion and said curved arm member being separated by a space or channel that is sized to receive a portion of a lengthwise or widthwise base frame member, said body portion having a vertically oriented bore therein for receiving an end of a corresponding vertically oriented member.

7. The machine tool shield according to claim 6 wherein said curved arm member of each center clip member has a degree of resiliency so as to allow said portion of a lengthwise or widthwise base frame member to be frictionally inserted into said channel or space of said center clip member.

8. The machine tool shield according to claim 1 further comprising a membrane under said base frame.

9. A base frame for a machine tool shield, comprising:
a frame member; and
at least one clip member mounted to said frame member, said clip member having a top portion, a body portion extending down from said top portion, and a curved arm member extending down from said top portion, said body portion and said curved arm member being separated by a space or channel that is sized to receive a portion of said frame member, said body portion having a vertically oriented bore therein for receiving an end of a vertically oriented shroud support member.

10. A corner clip member for use in assembling a base frame for a machine tool shield wherein said base frame has a plurality of base frame members arranged in the shape of a square or rectangle, the corner clip member comprising:
a first section having a first longitudinal axis, a top portion, a wall portion extending down from said top portion, and a curved arm member extending down from said top section, said wall portion and said curved arm member being separated by a channel or space that is sized for receiving a portion of a frame member of said base frame;
a second section having a second longitudinal axis that is substantially perpendicular to said first longitudinal axis, said second section further comprising a top portion, a wall portion extending down from said top portion of said second section, and a curved arm member extending down from said top portion of said second section, said wall portion of said second section and said curved arm member of said second section being separated by a channel or space that is sized for receiving a portion of a frame member of said base frame;
said top portion of said second section being continuous with said top portion of said first section; and
a generally central portion that is joined to said first and second sections, said central portion having said vertically oriented bore therein for receiving an end of a vertically oriented member.

11. The corner clip according to claim 10 wherein said curved arm member of said first section and said second section has a slight degree of resiliency so as to allow a portion of a base frame to be frictionally inserted into said channel or space.

12. The corner clip member according to claim 10 wherein the corner clip member is fabricated from a material chosen from the group polyvinylchloride, plastic, rubber, resin and composites.

13. A clip member for use in assembling a base frame for a machine tool shield wherein said base frame has at least one base frame member, said clip member comprising:
a top portion;
a body portion extending down from said top portion, said body portion having a vertically oriented bore therein for receiving an end of a vertically oriented member;
a curved arm member extending down from said top section; and
said body portion and said curved arm member being separated by a channel or space that is sized or for receiving a portion of said at least one base frame member.

14. The clip according to claim 13 wherein said curved arm member has a slight degree of resiliency so as to allow a portion of a base frame to be frictionally inserted into said channel or space.

15. The clip member according to claim 13 wherein the clip member is fabricated from a material chosen from the group polyvinylchloride, plastic, rubber, resin and composites.
